(19) United States
(12) Patent Application Publication
(10) Pub. No.: US 2001/0032172 A1
(43) Pub. Date: Oct. 18, 2001

(54) System and method for requesting proposals and awarding contracts for provision of services

(75) Inventors: Jesus A. Moulinet, Bellevue, WA (US); Mark X. Plog, Issaquah, WA (US); Thomas N. Woldendorp, Issaquah, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SurveyPlanet, Inc.

(21) Appl. No.: 09/809,782

(22) Filed: Mar. 16, 2001

Related U.S. Application Data
(60) Provisional application No. 60/190,313, filed on Mar. 17, 2000.

(51) Int. Cl. G06F 17/60

(52) U.S. Cl. 705/37

(57) ABSTRACT

Requesting a proposal and awarding a contract for provision of services is implemented by a local computing system, a remote computing system, and a service provider system. Proposal parameters and a service area requirement that define request for proposal (RFP) are used to screen a list of service providers. A short list of service providers is defined based on the service providers' qualifications. Using a single action, an RFP is simultaneously submitted to the service providers on the short list. A service provider retrieves from the remote computing system stored content for use in preparing a response to the RFP. The service provider system submits the response to the requesting party via the remote computing system. RFPs and responses thereto are tracked, with the status of the RFPs and responses being reported using various indicators. A contract for the provision of services is awarded to a winning service provider.

### CROSS-REFERENCE TO RELATED APPLICATION

The benefit of the filing date of U.S. Provisional Patent Application No. 60/190,313, filed Mar. 17, 2000, is claimed for this application under 35 U.S.C. § 119(e). Application No. 60/190,313 is hereby incorporated herein by reference.

### FIELD OF THE INVENTION

The present invention relates generally to procurement of services, and more particularly, to methods and systems using computer communication for obtaining provision of services.

### BACKGROUND OF THE INVENTION

The true cost of a service is determined not by the fee paid, but rather by the results achieved. This is particularly true with professional services. What one pays for is the result, and results depend on the quality of the services rendered. In most circumstances, a service provider's education, training, experience, and talents are primary determinants of the quality of service to be rendered.

One method used to select and retain professional services is bidding. A party requesting services publishes a minimum set of requirements in a solicitation for bids. Interested individuals and firms make a variety of assumptions about the requirements of the bid, unilaterally develop a scope of service that allows them to fulfill the assumed needs as cheaply as possible, and submit their bids to the requesting party. The lowest bidder typically wins the contract.

While bidding can minimize up-front costs, it may also produce undesirable results in the long term. Bidding encourages service providers to do the work as cheaply as they can. Furthermore, under a bidding process, there is an assumption that all firms and individuals being considered have the same qualifications and will apply the same amount of time, dedication, creativity, and ingenuity to the project, which is an unrealistic assumption. Bidding processes also often fail to provide adequate mechanisms to differentiate between highly-qualified service providers and marginally-qualified service providers. The only variable in a bidding process is the fee.

It is hence more desirable to use a qualification-based selection (QBS) process to select and retain professionals for the provision of services. Under QBS, it is anticipated that the requesting party will have the opportunity to review the qualifications of service providers and determine which ones are best suited for the project. This may involve collaboration with the selected service provider(s) to develop a mutually agreeable scope of service, after which the service provider(s) submit a fee proposal. Generally speaking, under QBS, identification of the most qualified firms and establishment of fee are sequential events.

Prior to the advent of computer-based communication via the Internet, parties interested in securing the services of others were faced with the challenge of contacting various service providers by telephone or mail and requesting that they send a brochure or other material that identifies their qualifications. Even a prequalification review to select service providers has been difficult to conduct. Directories, such as “yellow pages,” often do not contain sufficient information regarding the qualifications of service providers for an adequate review.

The Internet is now increasingly being used to conduct “electronic commerce,” in part because it facilitates electronic communications between parties. The Internet comprises a vast number of computers and computer networks interconnected through communication channels. Electronic commerce refers generally to commercial transactions at least partially conducted using the computer systems of the parties to the transactions.

As a matter of background, the Internet uses standardized techniques for exchanging information, such as electronic mail and the World Wide Web (“WWW”). The WWW service allows a remote server computer system (i.e., Web server or Web site) to send graphical Web pages of information to a local client computer system. The client computer system can then display the Web pages.

WWW resources (e.g., computers or Web pages) are uniquely identifiable by Uniform Resource Locators (“URLs”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends the requested Web page to the client computer system. When the client computer system receives that Web page, it typically displays the Web page using a browser. A browser is typically a special-purpose application program for requesting and displaying Web pages.

Web servers have been developed through which vendors can advertise and sell products. The products can include items (e.g., music) that are delivered electronically to the purchaser over the Internet and items (e.g., books) that are delivered through conventional distribution channels (e.g., a common carrier). A server computer system may provide an electronic version of a catalog that lists the items available. A user who is a potential purchaser may browse through the catalog using a browser and select various items to be purchased. After the user provides order information such as the user's name, the user's credit card number, and a shipping address for the order, the server computer system schedules shipment of the items.

Other types of commercial transactions are also conducted via the Web. For example, some server computer systems have been developed to support electronically-conducted auctions. The seller of an item provides a description of the item, an auction time period, and optionally a minimum bid to a server computer system. The server computer system then conducts the auction during the specified time period. Upon finding an auction of interest, a potential buyer can enter a bid for the item. At the close of the auction, the server computer system notifies the winning bidder and the seller (e.g., via electronic mail), so that they can complete the transaction.

The Web is also being used to unite sellers of goods or services, such as new or used cars, with purchasers wishing to buy such goods or services. For example, Autobytel.com provides a Web site at http.//www.autobytel.com, at which buyers may enter specific data with respect to an automobile they wish to purchase. The Autobytel.com Web site then forwards this data to a selected car dealer. The car dealer, in turn, contacts the buyer to provide additional information such as price, availability, options, and so forth. If the buyer wishes, the buyer may then visit the seller or otherwise consummate the transaction to purchase a desired car.

None of the above-described systems, however, provides a computer-based method of connecting service providers with potential clients who desire the providers' services based on the service providers' qualifications. Furthermore, none of the above-described systems provides an automated computer-based method for providing a project description to one or more service providers at the same time, receiving proposals from the service providers, and selecting a proposal from among the received proposals to award a contract for the provision of services. The present invention is directed to a method and system that overcomes the above-noted deficiencies and other shortcomings in the prior art.

### SUMMARY OF THE INVENTION

The present invention overcomes the limitations of the prior art and provides additional benefits. In one aspect, the present invention provides a method of requesting a proposal and awarding a contract for provision of services that is implemented by a local computing system, a remote computing system, and a service provider system. The method includes, under the control of the local computing system, preparing a request for proposal (RFP) defined by proposal parameters and a service area requirement. One or more of the proposal parameters and the service area requirement are used to screen a list of service providers identified by the remote computing system, resulting in a list of prospective service providers. The list of prospective service providers is comprised of service providers that provide services corresponding to one or more of the proposal parameters and meet the service area requirement. A short list of service providers selected from the list of prospective service providers is defined based on the service providers' qualifications. Using a single action of the requesting party (i.e., user), the RFP is simultaneously submitted to the service providers on the short list via the remote computing system.

Under the control of the service provider system, the RFP is received from the requesting party via the remote computing system. The service provider using the service provider system retrieves from a memory in the remote computing system stored content for use in preparing a response to the RFP. The stored content is associated in the remote computing system with one or more of the proposal parameters in the RFP. After the response to the RFP is prepared, the service provider system submits the response to the requesting party via the remote computing system.

According to another aspect of the invention, an RFP and responses thereto are tracked, with the status of the RFPs and responses being reported using various indicators. The RFP may be reported to be in a draft status, active status, pending, declined, received, or awarded status. A proposal submitted in response to an RFP may be reported as being in a draft status, submitted status, awarded, or lost status.

According to another aspect of the invention, a user of the local computing system may amend the RFP after the RFP has already been submitted to the service providers on the short list. Using a single action by the user, the local computing system simultaneously submits the amended RFP to the service providers on the short list via the remote computing system.

In yet another aspect of the invention, the user of the local computing system (i.e., requesting party) may automatically amend an RFP pursuant to a recommendation received from a service provider on the short list. The service provider's recommendation is identified with one or more of the proposal parameters, and upon agreement by the user of the local computing system, the RFP is amended and automatically transmitted to the service providers on the short list.

In a further embodiment of the invention, the user of the local computing system may add one or more service providers to the short list after the RFP has already been submitted. Using a single action of the user, the local computing system simultaneously submits the RFP to the added service providers via the remote computing system.

After having reviewed one or more proposals received from the service providers on the short list, the user of the local computing system may award a contract to a service provider on the short list. The remote computing system is used to simultaneously notify the service providers on the short list of the award.

A further aspect of the invention permits a service provider on the short list to amend a response to an RFP after having already submitted the response to the requesting party. The amended response is submitted to the requesting party by the service provider system via the remote computing system.

Other aspects of the present invention include a client system for requesting a proposal for provision of services, and a server system for responding to a request for a proposal for provision of services. The foregoing summary is intended to highlight and introduce some aspects of the disclosed embodiments, but is not intended to limit the scope of the invention.

### BRIEF DESCRIPTION OF THE DRAWINGS

The foregoing aspects and many of the attendant advantages of this invention will also become more readily appreciated as the same become better understood by reference to the following detailed description, when taken in conjunction with the accompanying drawings, wherein:

FIG. 1 is a pictorial diagram of a suitable computing environment in which the present invention can be implemented;

FIG. 2 is a flow diagram illustrating actions performed by a client system, a server system, and a service provider system as shown in FIG. 1, in accordance with one embodiment of the invention;

FIG. 3 is a pictorial diagram of a computer screen that can be used by a client system as shown in FIG. 1 in a performing a preliminary project assessment;

FIG. 4 is a pictorial diagram of a computer screen that can be used by a client system as shown in FIG. 1 for performing a prequalification review of service providers;

FIG. 5 is a pictorial diagram of a computer screen that can be used by a client system as shown in FIG. 1 for preparing a request for proposal (RFP) to be submitted to the service providers on a short list;

FIG. 6 is a pictorial diagram of a computer screen that can be used by a service provider system as shown in FIG. 1 for reviewing RFPs received from a client system;

FIG. 7 is a pictorial diagram of a computer screen that can be used by a service provider system for reviewing a particular RFP and/or preparing a proposal in response to an RFP;

FIG. 8 is a pictorial diagram of a computer screen that can be used by a client system for listing the projects initiated by a user of the client system;

FIG. 9 is a pictorial diagram of a computer screen that can be used by a client system for listing particular details of a selected project;

FIG. 10 is a flow diagram illustrating actions performed by a client system, server system, and service provider system in an exemplary embodiment of the invention, as shown in FIG. 1, for amending an RFP;

FIG. 11 is a flow diagram illustrating actions performed by the exemplary embodiment of the invention shown in FIG. 10 that permit a service provider to transmit a recommended amendment to an RFP to a requesting client, the recommended amendment being added to the RFP and automatically forwarded to the service providers on the short list upon client consent; and

FIG. 12 is a flow diagram illustrating actions performed by the exemplary embodiment of the invention shown in FIG. 10 for permitting a service provider to amend a response to an RFP, which in this case, the response being a proposal.

### DETAILED DESCRIPTION OF THE PREFERRED EMBODIMENT

The present invention is directed to an automated system for connecting potential customers with service providers using a computer-based proposal program. One actual embodiment of the invention is particularly useful for handling proposals for land surveying tasks. In this particular embodiment, land surveyors or firms providing land surveying services subscribe to a database that includes the firm's qualifications and the geographical areas in which the firm practices. Each potential customer accesses the database via a server system and searches for firms based on the type of surveying job required and the geographical area in which the survey is to be conducted. The potential customer is then presented with a list of surveying firms meeting the initial search criteria. The customer reviews the qualifications of the listed firms and selects qualified firms from the list. The customer can then simultaneously transmit to the qualified firms a request for proposal, which includes a more complete description of the parameters of the job to be performed. The selected surveying firms can, at their option, respond to the request for proposal with a proposal for completing the task. The potential customer reviews the proposals and selects a firm to provide the surveying services. The communications between the potential customer and the surveying firms take place over a computer network, such as the Internet, via a server system.

The following description provides specific details for a thorough understanding of, and enabling description for, embodiments of the invention. However, one skilled in the art will understand that the invention may be practiced without all of these details. Moreover, some well-known structures and functions have not been shown or described in detail to avoid unnecessarily obscuring the description of the embodiments of the invention. Alternatives and alternate embodiments described herein are substantially similar to previously described embodiments, with only significant differences in construction or operation described in detail.

Although not required, the embodiments of the invention will be described in the general context of computer-executable instructions, for example, routines executed by a general-purpose computer, such as a personal computer. However, those skilled in the relevant art will appreciate that the invention can be practiced with other computer system configurations, including Internet appliances, hand-held devices, cellular phones, multiprocessor systems, multiprocessor-based or programmable consumer electronics, network PCs, minicomputers, mainframe computers, and the like.

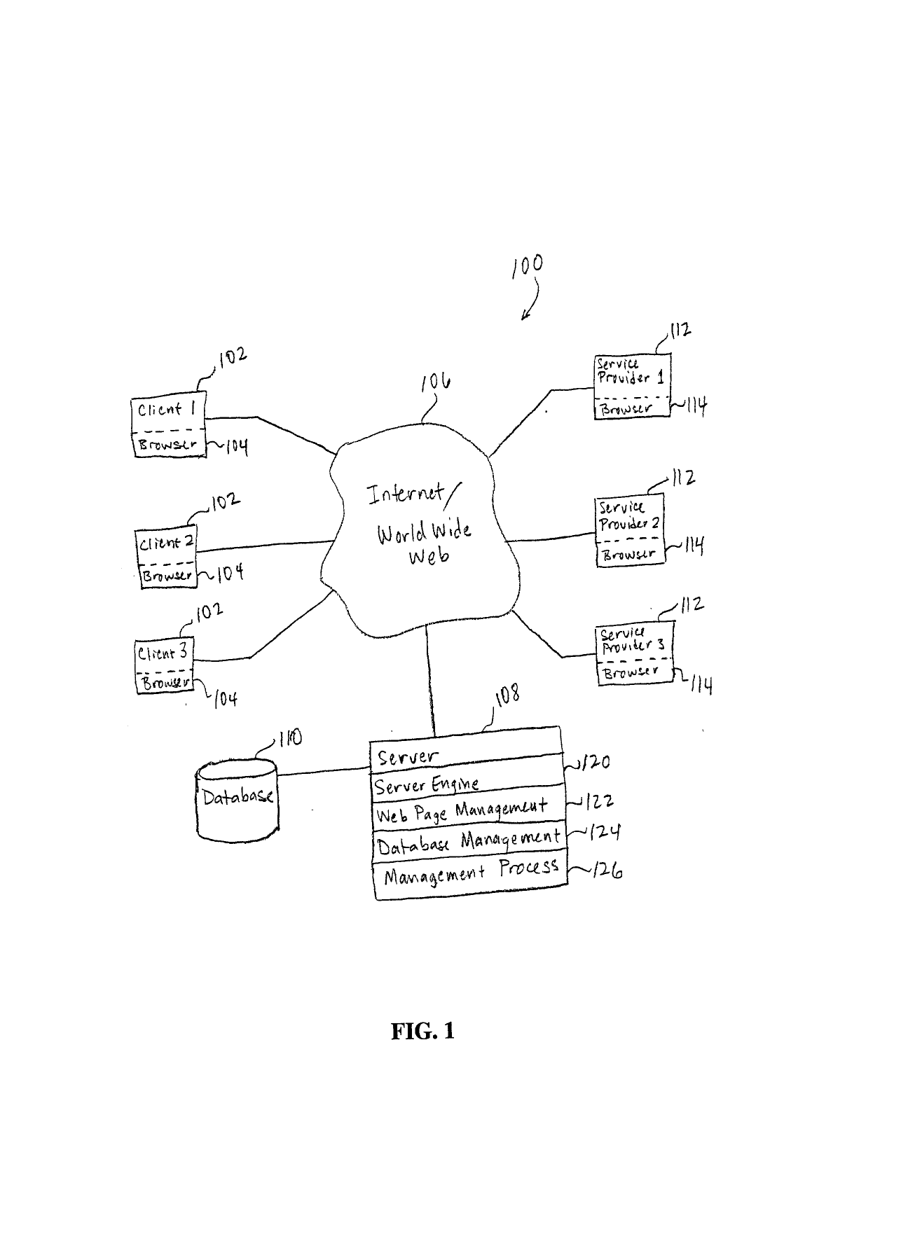

FIG. 1 provides a brief, general depiction of a suitable computing environment in which the invention can be implemented. Unless described otherwise, the construction and operation of the various blocks shown in FIG. 1 are of conventional design. As a result, such blocks need not be described in further detail herein, as they will be readily understood by those skilled in the relevant art.

As shown in FIG. 1, a proposal system 100 includes one or more local computing systems 102. Each of the local computing systems 102 includes a browser program module 104 that permits the local computing system to access and exchange data via the Internet, including with Web sites in a World Wide Web (“Web”) portion 106 of the Internet. In one embodiment of the proposal system 100, the local computing systems 102 are arranged as client systems in a client-server relationship with a remote server system 108 (described below). For ease of reference herein, and without limiting the scope of the computing systems that can be used for the local computing systems 102, the description of this particular embodiment of the invention interchangeably refers to the local computing systems as client systems.

The client systems 102 may include one or more central processing units or other logic processing circuitry, memory, input devices (e.g., keyboards and pointing devices), output devices (e.g., display devices, such as monitors and printers), storage devices (e.g, fixed, floppy and optical disk drives, magnetic cassettes, flash memory cards, digital video disks (DVDs), Bernoulli cartridges, RAMS, ROMs, smart cards, etc.), and communication components (e.g., modem or network interface card) for use in connecting to the Web 106. The client systems 102 may also include other program modules, such as an operating system, one or more application programs (e.g., word processing or spread sheet applications), and the like. The client systems 102 can be operated by a user, such as a customer or potential customer of goods and services.

A remote computing system, or server system 108, coupled to the Web 106, perform much or all of the searching process (described below) and interface between customers and service providers. Without limiting the scope of the computing systems that can be used for the remote computing system 108, the embodiment described in reference to FIG. 1 interchangeably refers to the remote computing system as a server system. A database 110, coupled to the server system 108, stores much of the data exchanged between the client systems 102, the server system 108 and one or more service provider systems 112. The service provider systems 112 are each operated by a service provider. The service provider systems 112 are similar to the client systems 102. Each service provider system 112 includes a browser 114 to permit the service provider system 112 to access and exchange information via the Web 106. The service provider systems 112 (as well as the client systems 102) may also be connected directly to the server system 108 (e.g., through a dial-up or direct network connection).

The server system 108 includes a server engine 120, a Web page management component 122, a database management component 124, a management process component 126, as well as other components, such as memory, not shown in FIG. 1. The server engine 120, the Web page management component 122, the database management component 124, and the management process component 126 operate together to retrieve information from the database 110 and to provide the information to the client systems 102 and/or the service provider systems 112. In one embodiment, the server system 108 and the database 110 form a single computing platform. Alternatively, the functions performed by the server system 108 and/or the database 110 can be distributed over a plurality of platforms.

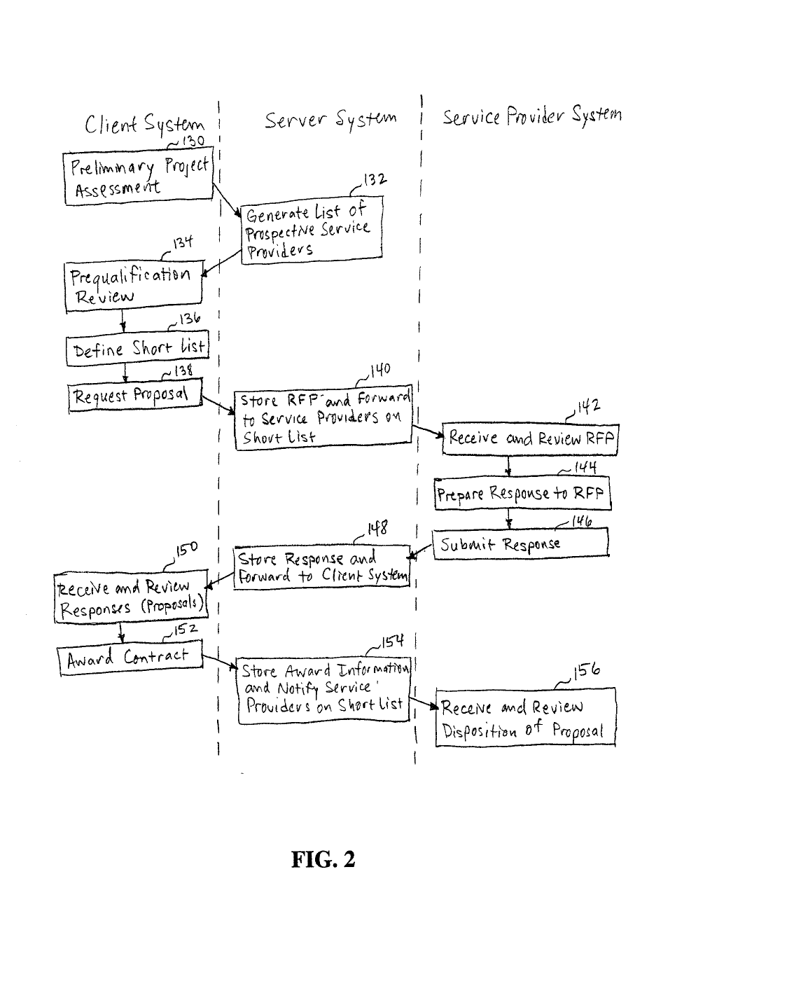

In accordance with the present invention, the proposal system 100 depicted in FIG. 1 is used by clients and prospective clients to request proposals and award contracts to service providers for provision of services. In one exemplary embodiment of the invention, as described by the flow diagram in FIG. 2, information is exchanged between a client system and a service provider system via a remote server system. The flow diagram in FIG. 2 illustrates various actions performed by the client system, server system, and service provider system in accordance with one embodiment of the invention. Dotted lines are used in FIG. 2 to separate the columns associated with the client system, server system, and service provider system. The actions performed by the various systems are aligned under the system that performs the majority of the described action.

Beginning at block 130, the user, or customer, using the client system undertakes a preliminary project assessment. At this stage, the user evaluates the scope of services desired for a project and enters one or more parameters that preliminarily define the project. The preliminary project scope preferably includes an assessment of the physical magnitude and resource requirements of the project. For example, the user may enter one or more proposal parameters identifying special expertise required for the project, a statement of work that defines the project, a desired time schedule, location, type of contract proposed, a projected budget, and service area for the project.

The service area for a project depends on the service industry in which the invention is implemented and the type of services to be performed. In the land survey industry, for example, the service area may be defined geographically by the physical location of the site to be surveyed. The service area for professional services may also (or alternatively) be defined by subject matter or jurisdiction (for example, the area in which the service provider is licensed to practice). The service area may be automatically determined from the proposal parameters (e.g., location where services are to be performed).

These preliminary proposal parameters and service area requirement are used to screen a list of service providers to identify those service providers who provide services corresponding to the one or more proposal parameters and meet the service area requirement. Accordingly, it is preferred that the user be guided by industry and service specific questions in developing the proposal parameters and service area requirement. Questions and suggested selections that are relevant to the user's needs are more helpful than providing a generic list of questions.

In order to perform a qualification-based review of service providers, it is anticipated that a previously-created list of service providers includes the qualifications of the service providers, including service area availability. This list of service providers may be stored in the database 110 as shown in FIG. 1. In regard to FIG. 2, one or more of the proposal parameters and the service area requirement defined at block 130 in the client system are communicated to the server system. The server system, in block 132 generates a list of prospective service providers by selecting from the list of service providers in the database those service providers that provide services corresponding to the one or more proposal parameters and meet the service area requirement. This list of prospective service providers is then communicated back to the client system for a prequalification review in block 134.

In an alternate embodiment of the invention, the server system may communicate to the client system the entire list of service providers in the database, with the client system generating the list of prospective service providers by selecting from the entire list of service providers those service providers that provide services corresponding to the one or more proposal parameters and meet the service area requirement. Moreover, in either of the foregoing embodiments of the invention, the server system or the client system may generate the list of prospective service providers by selecting only those service providers that provide services corresponding to all of the proposal parameters (and service area) defined in block 130.

The user of the client system performs a prequalification review (block 134) of the prospective service providers to assess the service providers' qualifications. The user uses the prequalification review to define a short list of service providers that appear to be best qualified for the project. The list of prospective service providers is preferably presented to the user in an order that is relevant to the user (e.g., sorted according to their proximity to the project, for users seeking land surveyors for a particular site). The user generally prepares the short list by selecting one or more of the service providers from the prequalification list, though it is within the scope of the invention for the client system to permit a user to manually add one or more service providers to the short list. In preparing the short list, the user may consider factors such as relevant experience, capacity to complete the work, experience and training of the service provider's staff, the service provider's past performance (e.g., performance on representative projects), and/or proximity of the service provider's office to the location where the services will be rendered. Depending on the project and the level of the user's comfort with the prequalification process, the user may choose to request additional, project-specific qualification information from one or more of the service providers prior to developing the short list. It is also within the scope of the invention for the user to request additional qualification information from the service providers in conjunction with a proposal request.

In connection with preparing the short list (i.e., either before, during or after defining the short list), the user uses the client system to complete the preparation of a request for proposal (RFP). An RFP is generally a formal statement of parameters that describes the scope of the project for which a proposal is requested. The RFP generally includes the proposal parameters and service area requirement set forth in the preliminary project assessment (block 130). Additional information, such as address, contact information, project description, unusual considerations, special needs, and time frame for responding with a proposal, may be added to the RFP.

At block 138, the user then submits the RFP to the service providers on the short list via the server system. In accordance with the invention, the client system is configured to permit the user to submit the RFP using a single action (e.g., the entry of a key or click of a pointing device), resulting in the RFP being communicated to the server system for simultaneous distribution to the service providers on the short list. At block 140, the server system receives the RFP from the client system and preferably stores the RFP in memory (e.g., RAM, hard disk, zip drive, optical disk, or other writable memory) in addition to simultaneously communicating the RFP to the service providers. The distribution of the RFP is “simultaneous” in the sense that the RFP is transmitted to the service providers on the short list in a short period of time so as to appear that the distribution occurred substantially at the same time.

At block 140, the server system may also save the user's short list in memory along with, or separately from, the RFP. Maintaining a short list of service providers in the server system's memory allows the user of the client system to later recall the short list for use in another project. In that regard, if one or more of the service providers in the stored short list meet the proposal parameters and service area requirements in a later project, the service providers may automatically be entered into the user's short list for the later project as a convenience to the user. A master short list (combining one or more previous short lists) may be kept by the server system. Alternatively, previous short lists of the user may be kept separately.

At block 142, the service provider systems receive the RFPs from the client system (via the server system) and provide the RFPs to the service providers for review. Each service provider system may use a display device, such as a computer monitor or printer, to provide the RFP to the service provider.

At this stage, a service provider assesses its ability to provide the requested services in the time frame and area requested. The service provider may also estimate the expected fee for performing the requested service. If the service provider is capable of performing the requested service and desires to do so, the service provider uses the service provider system to prepare a proposal in response to the RFP, as indicated at block 144.

A service provider's proposal may include various features such as an overview of the service provider, a statement of the services to be performed, the personnel to be used in providing the services, the dates and times at which the services will be rendered, expected fees for various aspects of the services, and terms for formation of a contract. While all of the content included in a proposal may be entered from scratch by the service provider, the present invention provides an advantageous feature of storing draft proposal content in the server system. If the service provider elects to use this feature of the invention, the service provider is provided an opportunity to submit content for storage in the server system for later use in preparing a proposal.

Preferably, for preparing a proposal, the service provider is provided with multiple data entry fields for entering different content to be associated with different aspects of the proposal parameters (e.g., firm overview content to be associated with a proposal request for background information). By storing draft proposal content in the server system in association with one or more proposal parameters, the service provider is able to recall the stored content and insert the content in the draft proposal with the stored content being automatically associated in the proposal with the proposal parameter to which it corresponds. For example, a proposal parameter in an RFP may specify that the services be performed by personnel having more than five years experience. In preparing a proposal, the service provider may recall information previously stored in the server system that identifies the service provider's personnel. From this information, the service provider may select stored content relating to key personnel having more than five years experience. Because of the proposal parameter association in the content database, the selected key personnel content is automatically entered into the corresponding field in the draft proposal.

If the service provider is not capable of providing the services requested, or does not desire to prepare a proposal, the service provider may alternatively decline the RFP. In that regard, the service provider system preferably provides the service provider with the option of “sending regrets” to the prospective client, that is, sending a response to the RFP expressing thanks for the consideration but respectfully declining the opportunity to submit a proposal.

Whether the service provider responds to the RFP with a proposal or with regrets, the service provider uses the service provider system to submit the response to the requesting client, as indicated at block 146. The response is communicated to the server system in block 148, and preferably the server system stores the response in its memory prior to forwarding the response to the client system.

At block 150, the client system receives the service provider's response. For those service providers providing a proposal, the client system displays the proposals for the user to review. In this regard, the user may systematically evaluate and rank each of the proposals against whichever criteria the user deems most appropriate. For example, this evaluation can involve preparation of a scoring sheet using a weighting or score for each criteria, such as service provider experience and references. If the project size and complexity warrants it, the user can include in the proposal evaluation interviews of key service provider personnel, visits to the premises of the service provider, discussions with the service provider's prior clients, and/or inspections of past projects.

Once the user has selected a winning proposal, the user may award a contract to the winning service provider for provision of the requested services, as indicated in block 152. As noted earlier, the terms of the contract may be included in the proposal prepared by the service provider (block 144). The client system communicates to the server system information regarding the awarded contract, as indicated in block 154, which the server system uses to simultaneously notify the winning and non-winning service providers on the short list.

When awarding the contract in block 152, the user may specify language to be used for communicating the award to the winning service provider. The user may also specify language to be used in notifying the non-winning service providers that the contract was awarded to another party, preferably with thanks to the non-winning service providers for their proposal submissions. At block 154, the server forwards the client-specified language to notify the respective service providers. Finally, at block 156, the service providers on the short list receive and review the disposition of the proposal.

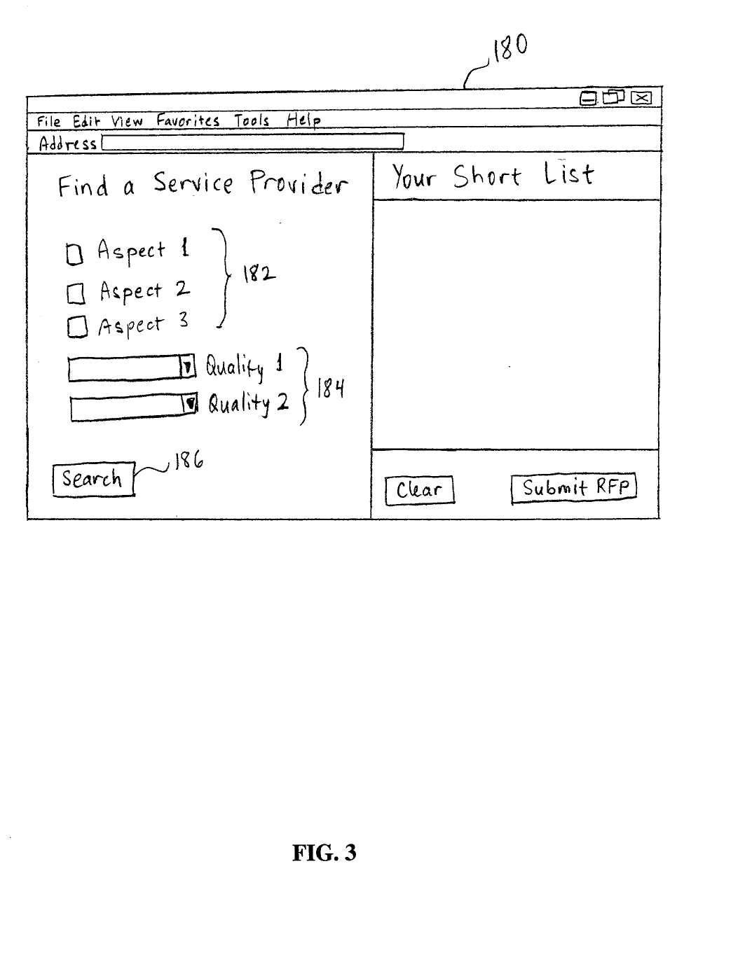

FIGS. 3-9 depict various computer screens that may be used in one or more embodiments of the invention to carry out the actions described in FIG. 2. The computer screens in FIGS. 3-9 are illustrative of exemplary embodiments of the invention, and should not be construed as limiting the invention to any particular interface. The computer screens are shown using a Web browser as discussed earlier in reference to FIG. 1.

FIG. 3 depicts a computer screen 180 that may be used by the client system in the preliminary project assessment discussed in connection with block 130 (FIG. 2). A user may use the screen 180 to specify the preliminary proposal parameters that are used to screen the list of service providers for prequalification review (block 134). As indicated at reference numeral 182, the user may specify one or more aspects of the project to be performed, such as location, type of service, and/or time frame. At reference numeral 184, the user may also specify one or more qualities required in the service provider or for the project, including the service area of the project. The proposal parameters identified by reference numerals 182 and 184 are not exhaustive of the parameters that may be established at this point in the proposal process, but are exemplary of the preliminary proposal parameters that may be set forth. To assist in establishing the proposal parameters, data entry devices, such as one or more drop-down boxes, may be used, as shown associated with the reference numeral 184. The drop-down boxes may suggest one or more parameters for the user to enter. Once the user has established the parameters for the prequalification review, the user initiates a search of the list of service providers, e.g., by clicking on a search button 186.

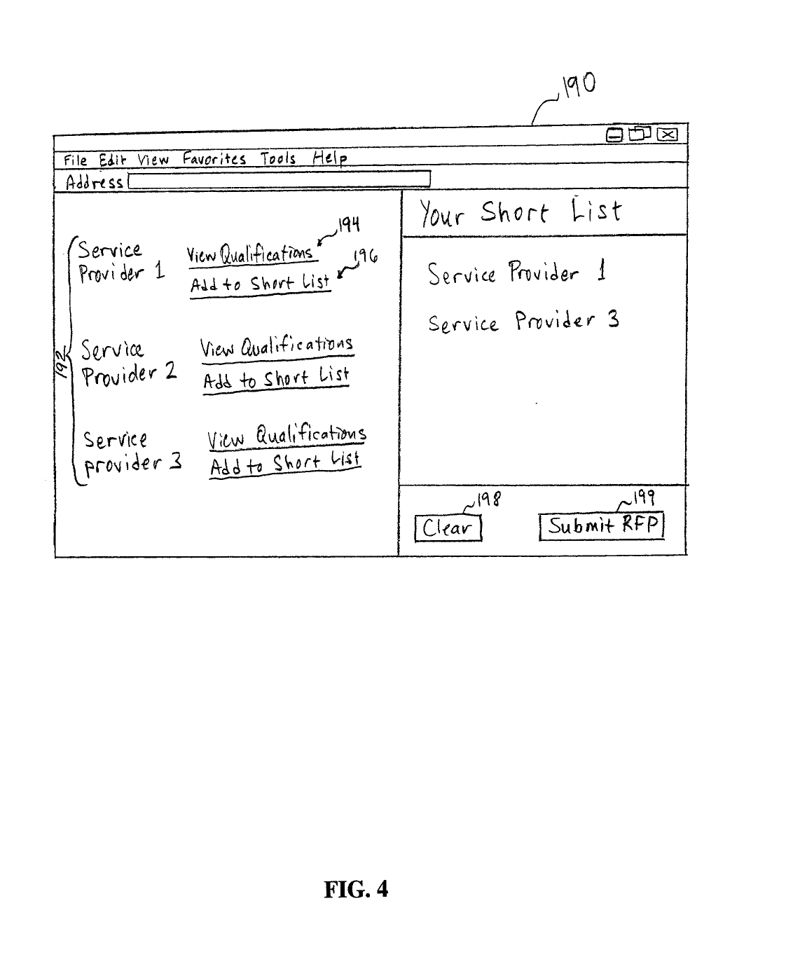

As discussed earlier with respect to FIG. 2, either the server system or the client system generates the list of prospective service providers (block 132) that provide services corresponding to the proposal parameters and service area set forth by the user (block 130). FIG. 4 illustrates a computer screen 190 in which a prequalification list of prospective service providers is displayed to the user. The list of prospective service providers is indicated by reference numeral 192. To perform the prequalification review, the user preferably reviews the qualifications of the identified service providers, e.g., by clicking on one of the “View Qualifications” hyperlinks 194, shown in FIG. 4, associated with the respective service providers 192. The “View Qualifications” hyperlink 194 for a service provider may open a new window on the computer screen (not shown) that lists in greater detail the qualifications of the particular service provider. The user may close or minimize this window to return to the computer screen 190. Alternatively, the hyperlink 194 may cause the computer screen 190 to shift to content relating to the particular service provider that is found elsewhere on the page being displayed.

After reviewing the service providers' qualifications, the user selects one or more of the service providers 192 to be added to the user's short list. To accomplish that task, the user may click on one of the “Add To Short List” hyperlinks 196 shown in FIG. 4 associated with the respective service providers 192. Upon clicking on an “Add To Short List” hyperlink 196 for a particular service provider, the service provider preferably appears on the right hand portion of the screen 190 under the title “Your Short List.” If, at any time, the user desires to clear one or more of the service providers off the short list, the user may press a “Clear” button 198 included on the screen 190.

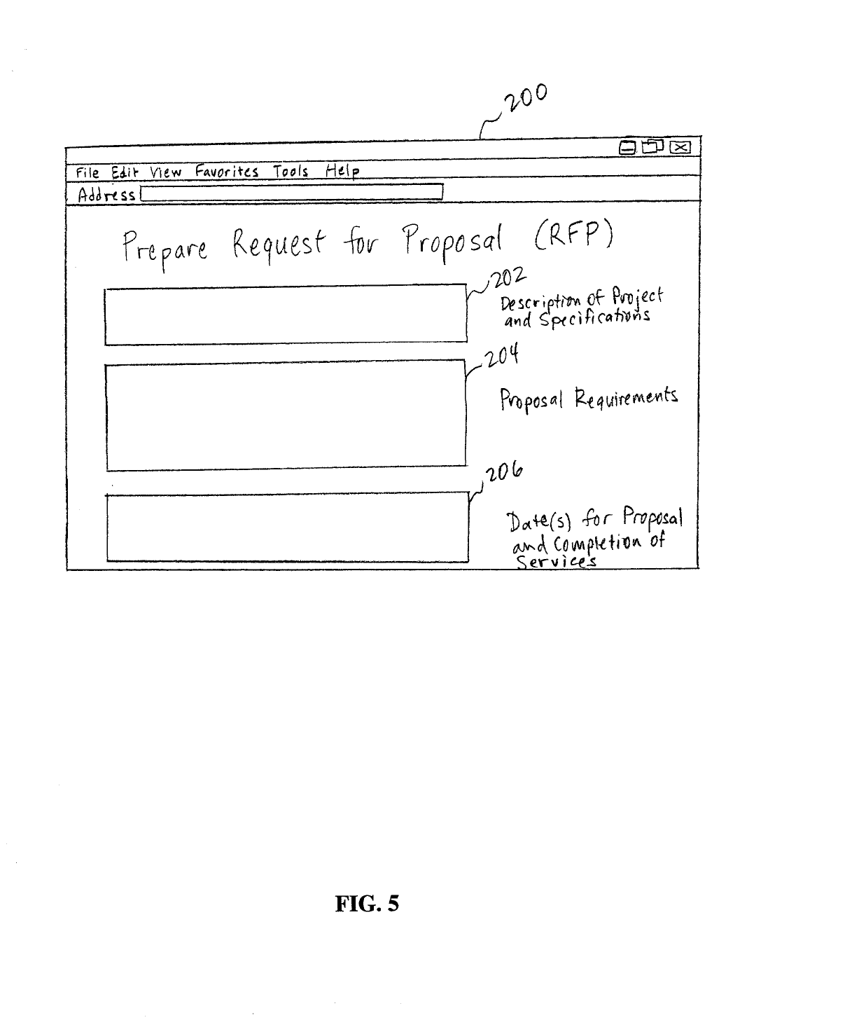

Prior to submitting a request for proposal (RFP) to the service providers on the short list, the user prepares the RFP. The computer screen 200 shown in FIG. 5 may be used for this action. In the screen 200, various data entry devices, such as text boxes, may be provided to the user to specify the parameters of the requested proposal. For example, at text box 202, the user may enter a description of the project and specifications therefor. In a text box 204, the user may enter other proposal requirements necessary to set forth the scope of the project. In a text box 206, the user may specify due dates for the service provider to respond with a proposal and complete the services requested. In addition to text boxes, other data entry devices, such as radio buttons and drop-down boxes, may be used in the screen 200. Furthermore, it is not anticipated that the request for proposal be limited to one computer screen. The computer screen 200 may depict only the top portion of a long Web page through which the user scrolls, or may depict the first of several sequential Web pages provided to the user. In any event, after the RFP is prepared, the client system may return to the computer screen 190 to permit the user to submit the RFP to the service providers on the short list by pressing, for example, the “Submit RFP” button 199.

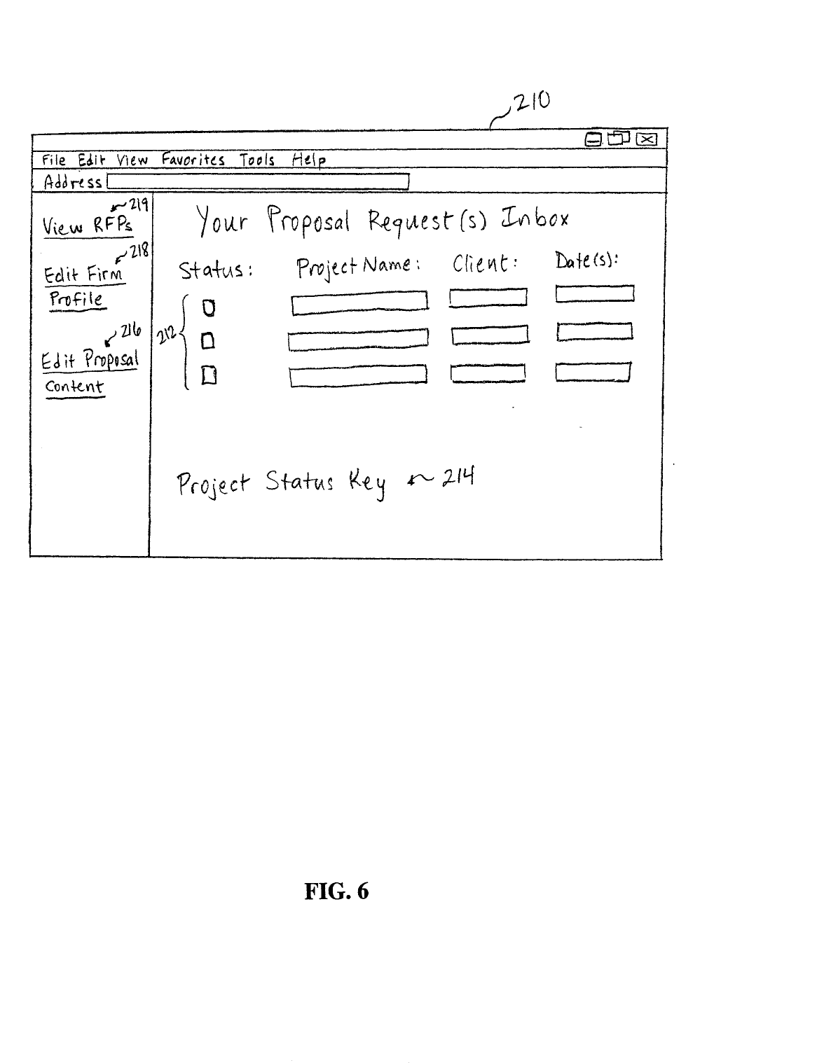

FIG. 6 depicts an exemplary computer screen 210 that can be displayed by the service provider system in connection with reviewing RFPs received from the client system (e.g., block 142 in FIG. 2). In the screen 210, a proposal request “inbox” lists RFPs received from the client systems. The inbox includes various fields such as “Status” (for indicating the status of the RFP), “Project Name” (for identifying the name assigned by a client system to the RFP), “Client” (identifying the client or prospective client that submitted the RFP), and “Date(s)” (indicating, for example, the due date for responding to the RFP). The RFPs identified in the inbox in the screen 210 may be listed alphabetically by the project name or client name, sequentially by date received or due date for response, or grouped by the status of the RFP.

In regard to the proposal “Status” field, the proposal system of the present invention preferably tracks the RFPs and reports the status of the service provider's corresponding proposals using one or more status indicators. For example, the status field shown in the screen 210 includes icons 212 that report the status of the proposals. A project status key 214 at the bottom of the screen 210 reminds the service provider of the meaning of the various icons 212.

Different icon designs may be used to indicate different stages of the proposal. For example, one icon design may indicate that the proposal is in a “draft” status in which the service provider has begun preparation of a response but has not submitted the response to the requesting client. Another icon design may be used to report that the proposal is in a “submitted” status in which a completed proposal has been sent to the requesting client. Another icon design may be used to report that the proposal has been “awarded,” that is, the proposal sent to the client has been reviewed and accepted by the client. If the proposal sent to the client was awarded to another party, a different icon design may be used to indicate that the proposal has been “lost.”

As noted earlier with respect to block 144 in FIG. 2, one aspect of the invention provides a feature whereby a service provider may store content on the server system for use in preparing proposals. In the computer screen 210 shown in FIG. 6, a hyperlink 216 titled “Edit Proposal Content” may be used to guide the service provider to one or more screens (not shown) in which the service provider is permitted to enter and/or modify draft proposal content stored at the server system. The server system preferably associates the stored content to one or more parameters used in a proposal.

The computer screen 210 further provides a hyperlink 218 titled “Edit Firm Profile” that, when clicked on, guides the service provider to one or more screens (not shown) that enable the service provider to enter and/or modify a description of the service provider stored at the server system. A “firm profile” may be used by both individuals and service provider companies. A firm profile stored at the server system is preferably divided into fields that correspond with parameters used by a prospective client in the preliminary project assessment (block 130), including the service areas for which the service provider is available. If the service provider has previously clicked on hyperlinks 216 or 218, the service provider may click on the hyperlink 219 titled “View RFPs” to return to the proposal request inbox shown in FIG. 6.

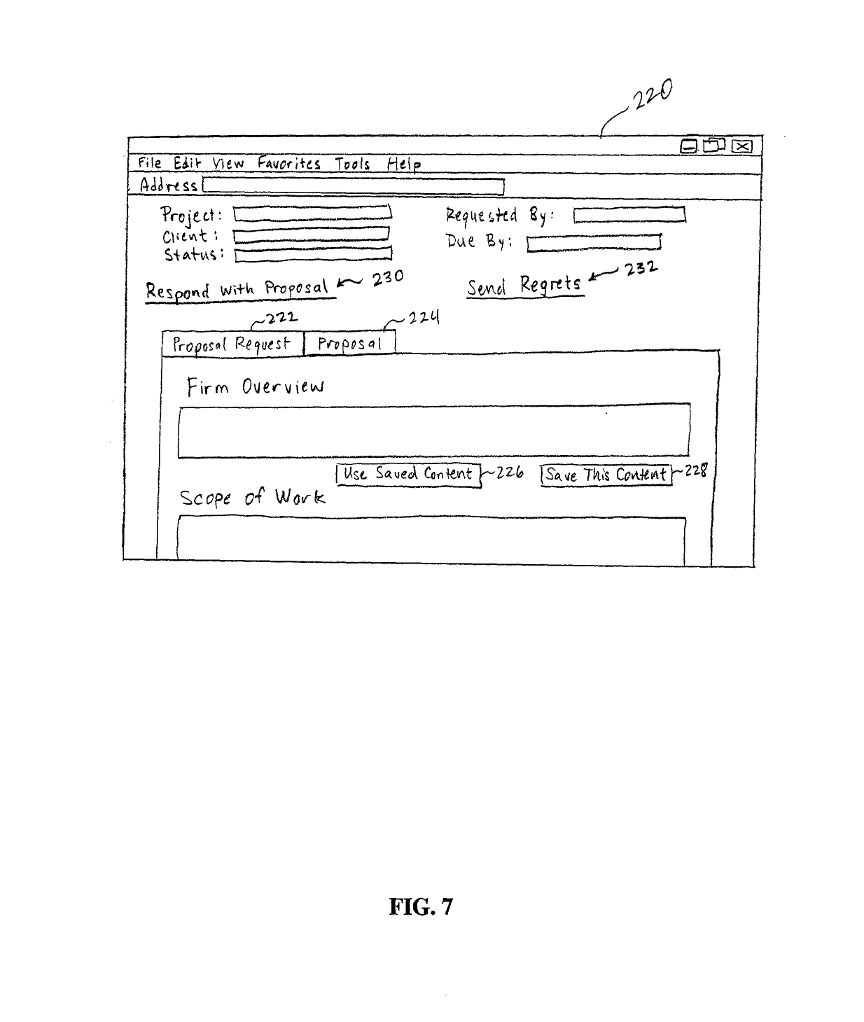

As one skilled in the art will appreciate, any of the information shown in a computer screen, such as the screen 210, may be hyperlinked to one or more screens that provide additional information or permit further action to be taken. For example, the client names listed under the “Client” field in the screen 210 may be hyperlinked to one or more screens that provide additional information regarding the particular client that was clicked on. This client-related information may be stored at the server system and downloaded for display by the service provider system as requested. The project names listed under the “Project Name” field in the screen 210 may also be hyperlinked to a screen, as represented by screen 220 (FIG. 7) that permits the service provider to review the particular proposal request and/or prepare a proposal in response to the RFP.

The computer screen 220, shown in FIG. 7, preferably provides relevant information regarding the project set forth in a particular RFP, such as project name, client name, status, requested date, and/or due date for the response. The service provider may view the details of the RFP by clicking on a tab 222 titled “Proposal Request.” By clicking on the “Proposal Request” tab 222, the service provider is provided with one or more screens (not shown) that display the full contents of the RFP as submitted by the client system (block 138).

If the service provider clicks on the tab 224 titled “Proposal,” the service provider is preferably provided with one or more screens that allow the service provider to prepare a proposal in response to the RFP, as depicted in the screen 220. To prepare the proposal, the service provider may enter information using text fields, such as those shown in the screen 220 under the titles “Firm Overview” and “Scope of Work.” As discussed earlier, the service provider may enter information into these text fields from scratch. If the service provider has previously stored content for use in preparing a proposal, the service provider may click on a “Use Saved Content” button 226 to retrieve the stored content for that field. In accordance with the invention, the server system has previously associated stored content with the Firm Overview portion of the proposal so that when the service provider clicks on the button 226, the stored content is automatically retrieved from the server system and inserted in the appropriate text box. If the service provider has entered the Firm Overview information from scratch, the service provider may use the “Save This Content” button 228 to upload the entered information for storage in the service system. A similar process may be used for other fields in the proposal (e.g., the “Scope of Work” field), as desired.

It is normally expected that the proposal will include more than the two fields as shown in the screen 220. Accordingly, those skilled in the art will recognize that the screen 220 may represent only the first of several screens used for preparing the proposal, or alternatively, the screen 220 may represent only the top portion of a longer page through which the service provider can scroll to prepare the proposal.

Once the proposal is completed, the service provider may use the “Respond With Proposal” hyperlink 230 to submit the proposal to the requesting client via the server system. Alternatively, if the service provider decides not to submit a proposal, the service provider may click on the “Send Regrets” hyperlink 232 to notify the requesting client that a proposal will not be submitted.

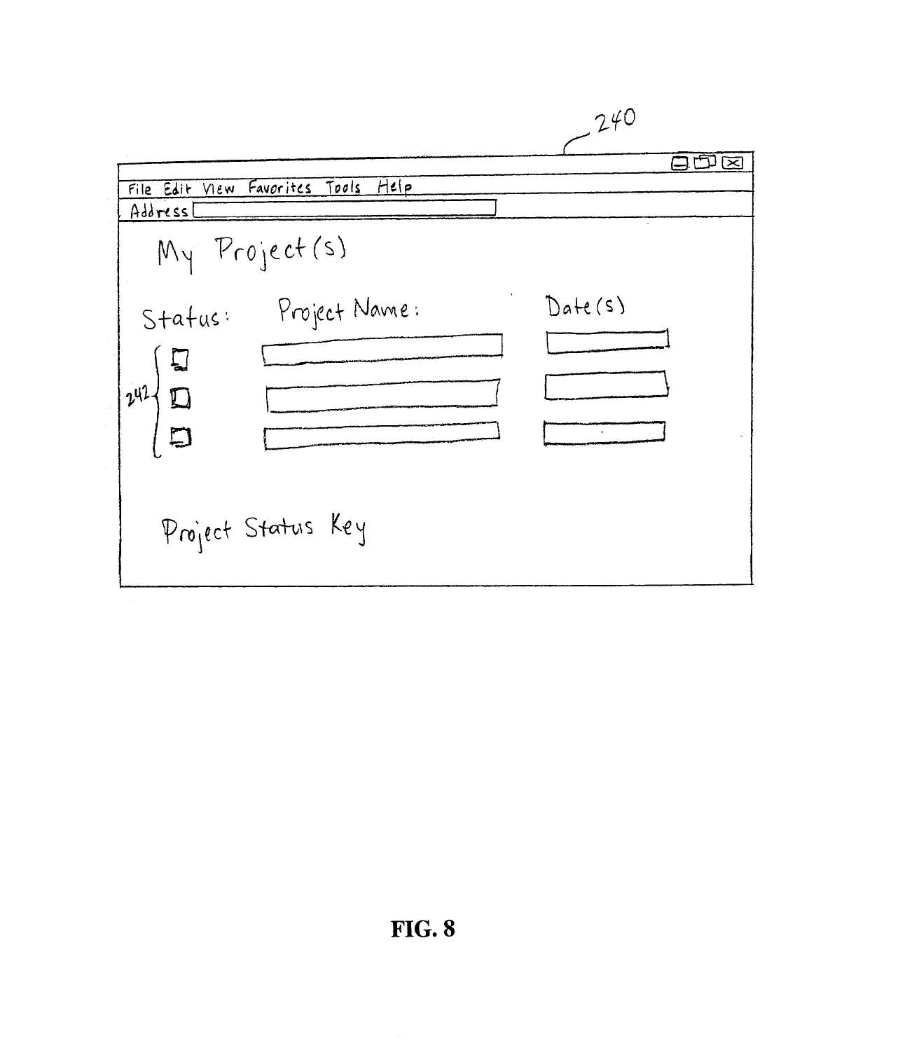

FIG. 8 depicts a computer screen 240 that can be displayed by the client system in one embodiment of the invention. The screen 240 provides a listing of the projects initiated by the user of the client system. In a format similar to the proposal request inbox shown in the screen 210 in FIG. 6, the screen 240 includes various fields for identifying the user's projects and their status. For example, the screen 240 provides fields for “Status,” “Project Name,” and “Date(s).” The project names listed on the screen 240 are the project names assigned by the user when the RFP for the project was prepared (block 138 in FIG. 2). The dates listed on the screen 240 may include the dates that the RFP was created, sent to the service providers on the short list, and/or due dates for receipt of a proposal or completion of the project.

In accordance with the present invention, the various RFPs prepared and submitted by the user of the client system are tracked so that the status of the RFPs can be reported to the user. As shown in the screen 240, the “Status” field provides indicators 242 that report the status of the respective RFPs. In one embodiment of the invention, the indicators 242 are icons having different designs that report the various status conditions of the RFPs. For example, one icon design may be used to report that an RFP is in a “draft” status, that is, the RFP has not yet been submitted to the service providers on the short list. Another icon design may be used to report that the RFP is in an “active” status, that is, that the RFP has been submitted to the service providers on the short list. Other icon designs may be used to report that a proposal for the RFP has been received and another reporting that a contract for a proposal has been awarded.

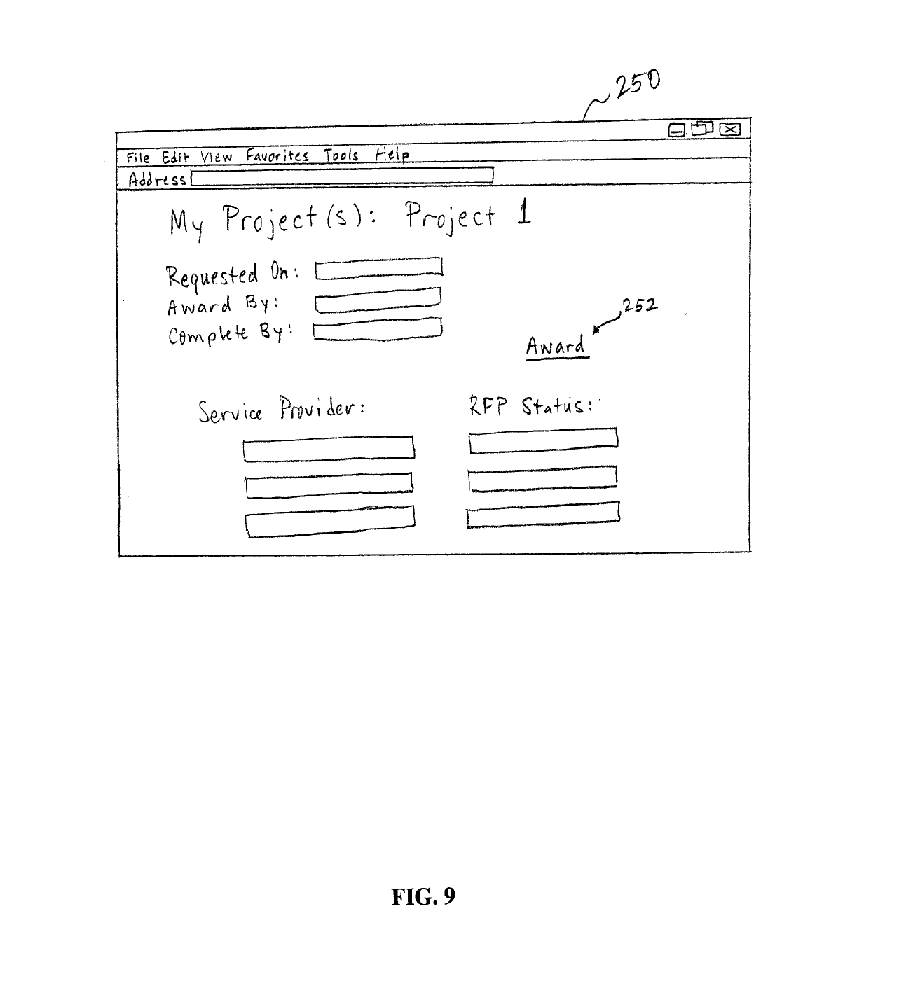

The project names identified under the “Project Name” field may be hyperlinked to additional screens that provide details on the respective projects, including the RFP prepared for the project. For example, clicking on a selected project name listed in the screen 240 may produce for the user the computer screen 250 shown in FIG. 9. In the computer screen 250, initial information on the selected project is preferably provided, which may include the date that the RFP was submitted, the date by which the proposal should be awarded, and the date by which the project should be completed. The computer screen 250 further includes fields that identify the service providers to whom the RFP was submitted and the status of the RFP for each of the identified service providers.

It will be appreciated by those of ordinary skill in the art that providing the status of an RFP for a particular service provider does not necessarily have to be in the form of a graphical icon, as shown in the screens 210 and 240. Alternatively, as shown in the screen 250, a text field may be used to report the status of an RFP. In further embodiments of the invention, color schemes or sound may be used to report status. Preferably, for each service provider that received the RFP, the “RFP Status” field in the screen 250 reports whether the RFP is pending (i.e., indicating that the service provider may still respond to the RFP but has not yet done so), whether the RFP has been declined (i.e., the service provider has sent regrets, e.g., by using the hyperlink 232 shown in FIG. 7), or whether a proposal for the RFP has been received from the service provider.

Once the user of the client system has received one or more proposals, the user may review the proposals, as indicated at block 150 in FIG. 2, to determine which proposal, if any, will be awarded. Once an acceptable proposal has been received and the user desires to award a contract for the proposal, the user may click on the “Award” hyperlink 252 which produces one or more additional screens (not shown) that allows the user to specify which service provider is to receive the award, the language to be used in awarding the contract, and language to be used in thanking the non-awarded service providers for their proposals.

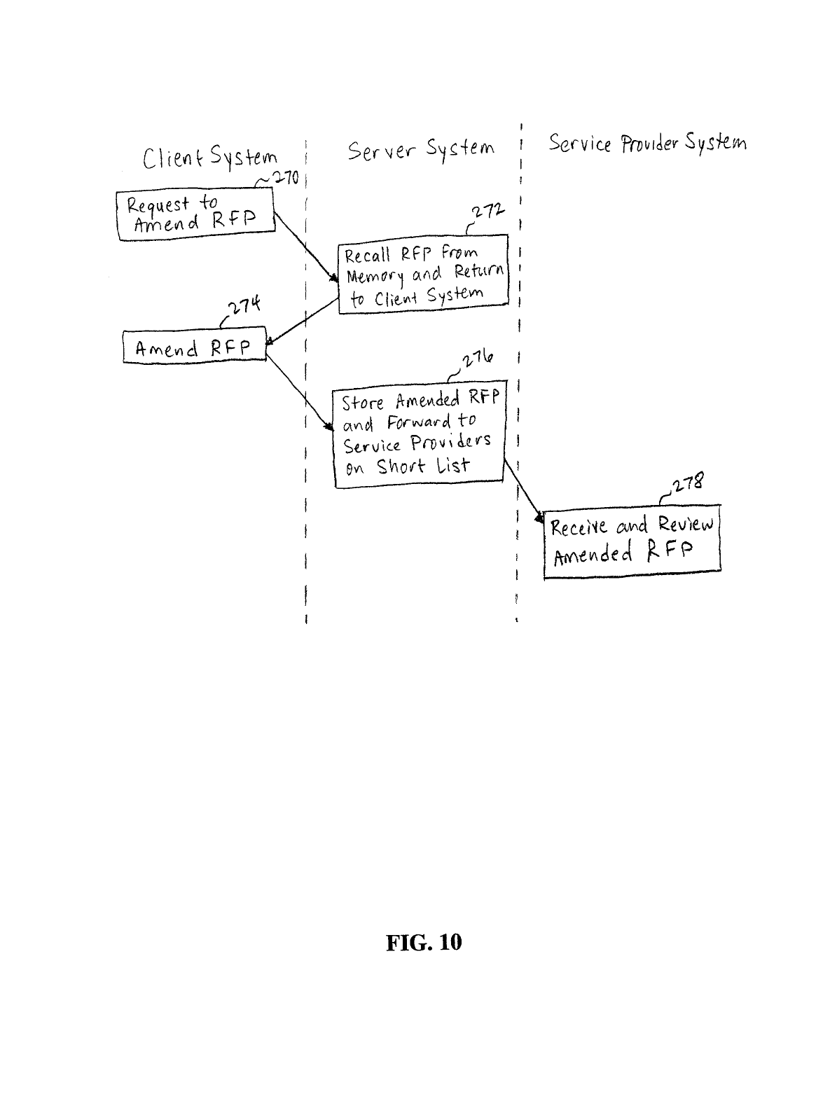

In some circumstances, a user may wish to amend an RFP after it has already been submitted to the service providers on the short list. The flow diagram in FIG. 10 illustrates various actions performed in an exemplary embodiment of the invention for amending an RFP. At block 270, the user of the client system enters a request to amend a previously-submitted RFP. If the RFP was not saved in a memory at the client system, the client system may forward the request to the server system, as shown in FIG. 10. At block 272, the server system recalls the RFP from its memory and returns the RFP to the client system.

At block 274, the user of the client system amends the RFP as desired. The user then submits the amended RFP to the service providers on the short list via the server system. At block 276, the server system stores the amended RFP in its memory and forwards the amended RFP to the service providers on the short list. At block 278, a service provider system receives the amended RFP and provides the amended RFP to the service provider for review. At this point, the service providers are afforded the opportunity to respond to the amended RFP in a manner as described with respect to blocks 144 and 146 in FIG. 2.

If any of the service providers on the short list had previously responded to the RFP before receiving the amended RFP, it is preferable that the service provider be afforded opportunity to withdraw the prior response, in favor of further evaluation of the amended RFP. The service provider may then prepare a new response to the RFP and submit the response to the requesting client in a manner as described with respect to blocks 144 and 146 in FIG. 2.

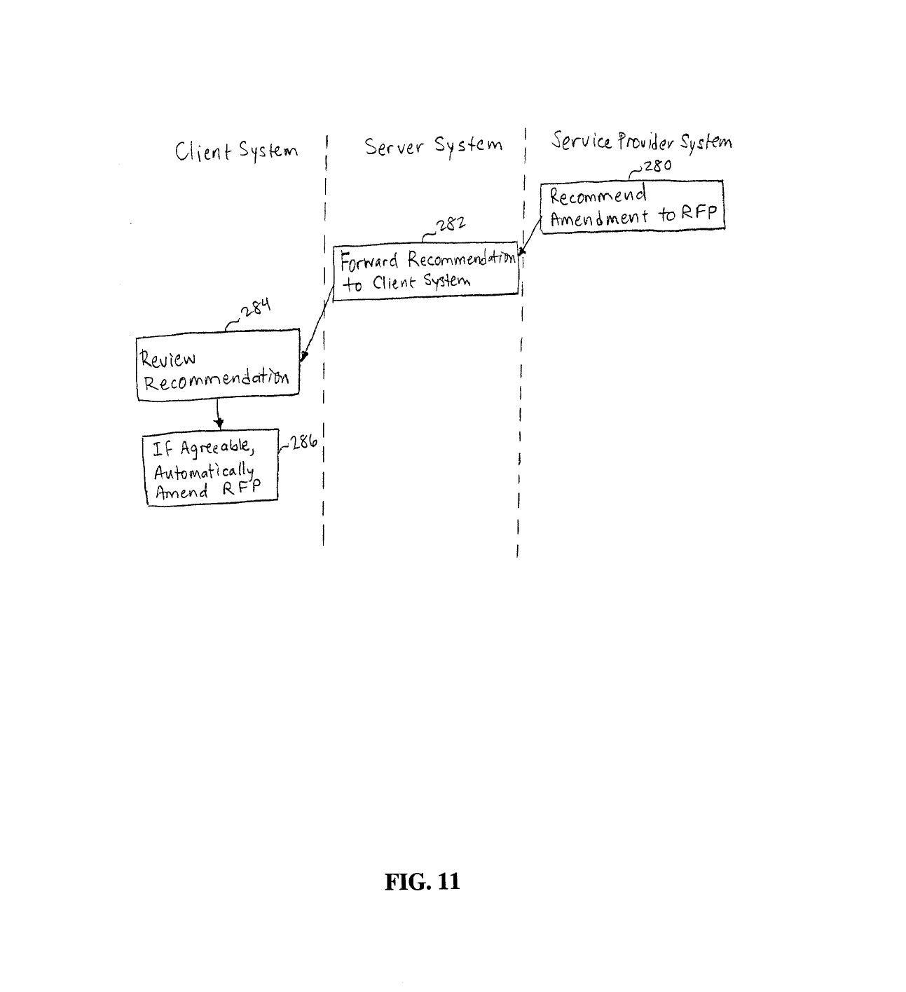

In other circumstances, a service provider, having reviewed the RFP of a requesting client, may have recommendations to the client to amend the RFP. It may be that certain aspects of the RFP are not feasible, or that the quality of the job could be significantly improved by changing some aspect of the RFP. In that regard, as shown in FIG. 11, the service provider may prepare and send a recommended amendment to the RFP to the requesting client, as indicated at block 280. Recommended amendments are identified with one or more of the proposal parameters. The recommended amendment is communicated to the server system (which, if advantageous, may record the recommended amendment in its memory). The server system forwards the recommended amendment to the client system, as indicated at block 282. At block 284, the user of the client system reviews the recommended amendment. If the user agrees with the recommendation, the user indicates the agreement to the client system. In response thereto, at block 286, the client system amends the RFP per the recommendation and automatically submits the amended RFP to the service providers on the short list via the server system (e.g., in a manner as described with respect to blocks 274, 276, and 278 in FIG. 10).

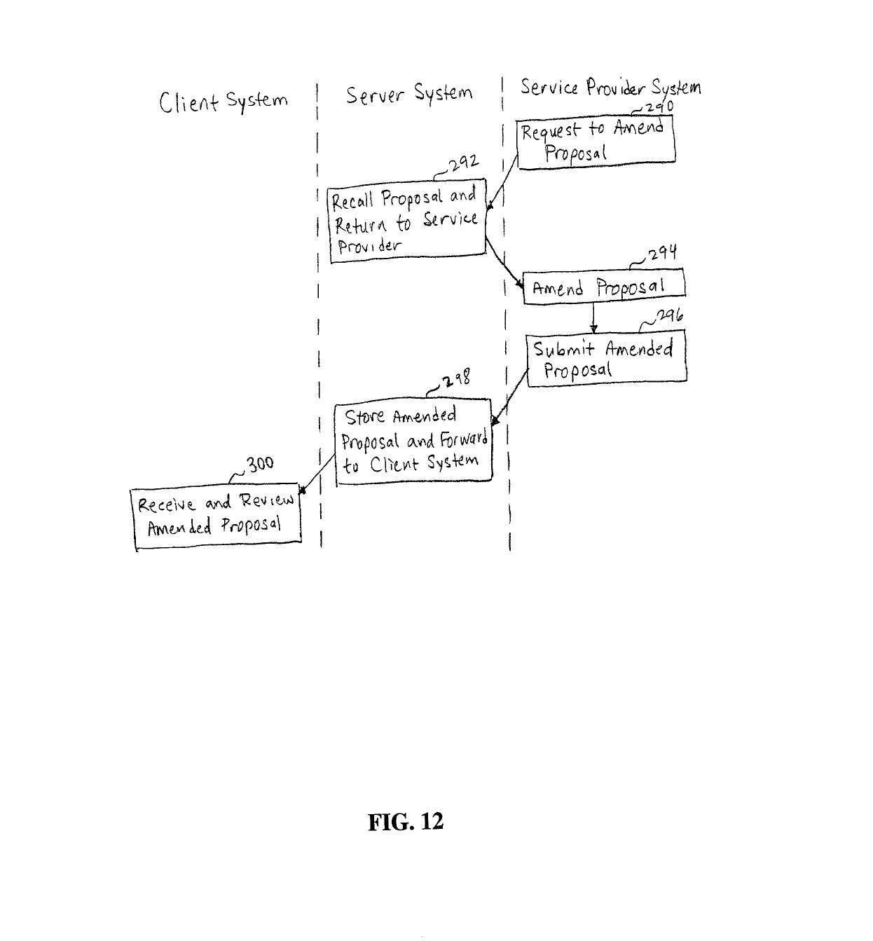

A further embodiment of the invention permits a service provider to amend or change a response (i.e., a proposal or a note declining the RFP) that has already been submitted to the client in response to an RFP. For a previously submitted proposal, at block 290 in FIG. 12, the service provider enters a request to amend the proposal. If the proposal was not saved in a memory at the service provider system, the service provider system may communicate the request to the server as shown in FIG. 12. At block 292, the server system recalls the proposal from its memory and returns it to the service provider.

At block 294, the service provider amends the proposal as desired, and at block 296, submits the amended proposal to the requesting client via the server system. The amended proposal is transmitted to the server system that, as indicated at block 298, may store the amended proposal in its memory. The server system forwards the amended proposal to the client system, and at block 300, the client system receives the amended proposal and provides the amended proposal to the user for review. At this point, it is normally expected that the amended proposal supersedes the previous proposal that the user received from the service provider. Accordingly, the amended proposal preferably replaces the previously submitted proposal in the client system.

In yet another embodiment of the invention, a user of the client system may be permitted to add service providers to the short list after an RFP has already been submitted. The client system permits the user to further define the short list (e.g., as described at block 136 in FIG. 2) with the additional one or more service providers being listed under the “Your Short List” field (e.g., as shown in the screen 190). The RFP, as previously prepared by the user, is then forwarded to the added service providers (e.g., in a manner as discussed with respect to blocks 138, 140, and 142).

The client system may also permit the user to delete one or more service providers from the short list after the RFP has been submitted. Removing one or more service providers from the short list, in effect, cancels the RFP with respect to the removed service provider. In that regard, the client system communicates the cancellation to the particular service provider via the server system. In the service provider's proposal “inbox”, an example of which is shown in FIG. 6, the particular project status would indicate that the RFP has been cancelled.

One skilled in the art will appreciate that the concepts disclosed in the above embodiments can be used in various environments other than the Internet. For example, the concepts can be used in an electronic mail environment in which an electronic mail server provides forms, messages, and otherwise maintains addressing for mail recipients. In general, a display description such as a Web page or computer display may be in HTML format, email format, or any other format suitable for displaying information (including character/code based formats, bit mapped formats or vector formats). Also, various communication channels, such as local area networks (LAN), wide area networks (WAN), point-to-point dial-up connections, or wireless connections may be used instead of the Internet.

Furthermore, while a remote computer server is generally described herein, any server system may be used, including any combination of hardware or software that can support the concepts and aspects of the invention. In particular, a Web server may be used that includes multiple components. A client computer system may comprise any combination of hardware or software that interacts with the server computer, database server, Web server or other aspects of the system. These client systems may include telephone-based systems, Internet appliances, palm top or wearable computers, and various other consumer products through which transactions can be conducted.

The foregoing description of illustrated embodiments of the invention is not intended to be exhaustive or to limit the invention to the precise forms disclosed. The teachings of the invention provided herein can be applied to other systems, not necessarily described above. The invention may also be applied to different service industries. In that regard, software implementing the invention may be “white labeled,” which would allow for easy customization of the software to fit the needs of specific industries. Furthermore, the various embodiments described above can be combined to provide further embodiments. These and other changes can be made to the invention in light of the above detailed description. For these reasons, the scope of the invention should be determined from the following claims, and equivalents thereto.

The embodiments of the invention in which an exclusive property or privilege is claimed are defined as follows:

1. A method of requesting a proposal and awarding a contract for provision of services, comprising:
(a) under the control of a local computing system:
(i) preparing a request for proposal (RFP) defined by proposal parameters and a service area requirement;
(ii) performing a qualification-based review of service providers in a list of service providers identified by a remote computing system, the list under review comprising prospective service providers that provide services corresponding to one or more of the proposal parameters and meet the service area requirement;
(iii) defining a short list of service providers selected from the list of prospective service providers based on the service providers' qualifications;
(iv) using a single action, simultaneously submitting the RFP to the service providers on the short list via the remote computing system;
(v) reviewing one or more proposals received from the service providers on the short list via the remote computing system; and
(vi) awarding a contract to a service provider on the short list based on the one or more proposals received; and
(b) under the control of the remote computing system:
(i) identifying to the local computing system a list of service providers that includes qualifications and available service areas of the service providers;
(ii) receiving the RFP from the local computing system;
(iii) simultaneously forwarding the RFP to the service providers on the short list; and
(iv) forwarding to the local computing system for review, one or more proposals received from the service providers on the short list in response to the submitted RFP.

2. The method of claim 1, further comprising under the control of the local computing system, forwarding to the remote computing system one or more of the proposal parameters and service area requirement, and in response thereto, under the control of the remote computing system, generating the list of prospective service providers by selecting from a database in the remote computing system those service providers that provide services corresponding to one or more of the proposal parameters and meet the service area requirement.

3. The method of claim 2, wherein the remote computing system selects from the database only those service providers that provide services corresponding to all of the proposal parameters.

4. The method of claim 1, wherein the local computing system generates the list of prospective service providers by selecting from the list of service providers identified by the remote computing system those service providers that provide services corresponding to one or more of the proposal parameters and meet the service area requirement.

5. The method of claim 4, wherein the local computing system selects only those service providers that provide services corresponding to all of the proposal parameters.

6. The method of claim 1, further comprising storing the RFP in a memory at the remote computing system.

7. The method of claim 1, further comprising storing the short list in a memory at the remote computing system.

8. The method of claim 1, further comprising tracking the status of the RFP and displaying at the local computing system an indicator reporting the status of the RFP.

9. The method of claim 8, wherein the indicator reports that the RFP is in a draft status.

10. The method of claim 8, wherein the indicator reports that the RFP is in an active status.

11. The method of claim 8, wherein, for a particular service provider on the short list, the indicator reports that the RFP is pending.

12. The method of claim 8, wherein, for a particular service provider on the short list, the indicator reports that the RFP has been declined.

13. The method of claim 8, wherein, for a particular service provider on the short list, the indicator reports that a proposal for the RFP has been received.

14. The method of claim 8, wherein the indicator reports that the RFP has been awarded.

15. The method of claim 1, further comprising under the control of the local computing system, amending the RFP after the RFP has been submitted to the service providers on the short list and, using a single action, simultaneously submitting the amended RFP to the service providers on the short list via the remote computing system.

16. The method of claim 15, further comprising under the control of the local computing system, automatically amending the RFP pursuant to a recommendation received from a service provider on the short list via the remote computing system, the recommendation being identified with one or more of the proposal parameters.

17. The method of claim 1, further comprising under the control of the local computing system, adding one or more service providers to the short list after the RFP has been submitted and, using a single action, simultaneously submitting the RFP to the added service providers via the remote computing system.

18. The method of claim 1, wherein awarding the contract includes advising the remote computing system of the award, the method further comprising, under the control of the remote computing system, simultaneously notifying the awarded service provider and the non-awarded service providers of the award.

19. A method of receiving and responding to a request for a proposal for provision of services, comprising:
(a) under the control of a service provider system,
(i) receiving a request for proposal (REP) from a requesting party via a remote computing system, the RFP having previously been submitted to the remote computing system by the requesting party;
(ii) retrieving from a memory in the remote computing system stored content for use in preparing a response to the RFP, the stored content being associated in the remote computing system with one or more of the proposal parameters in the RFP;
(iii) preparing the response to the RFP using the stored content;
(iv) submitting the response to the requesting party via the remote computing system; and
(b) under the control of the remote computing system:
(i) forwarding to the service provider system the RFP received from the requesting party; and
(ii) forwarding to the requesting party the response received from the service provider system.

20. The method of claim 19, wherein the stored content was previously submitted to the remote computing system by the service provider system.

21. The method of claim 19, wherein the response constitutes a proposal, the method further comprising tracking the status of the proposal and displaying, at the service provider system, an indicator reporting the status of the proposal.

22. The method of claim 21, wherein the indicator reports that the proposal is in a draft status.

23. The method of claim 21, wherein the indicator reports that the proposal is in a submitted status.

24. The method of claim 21, wherein the indicator reports that the proposal has been awarded.

25. The method of claim 21, wherein the indicator reports that the proposal has been lost.

26. The method of claim 19, further comprising under the control of the service provider system, using the stored content to decline the RFP, the stored content including a message of regret that may be modified by the service provider system prior to submitting the message to the requesting party via the remote computing system.

27. The method of claim 19, further comprising under the control of the service provider system, amending the response to the RFP after the response has already been submitted, the amended response being submitted to the requesting party via the remote computing system.

28. A client system for requesting a proposal for provision of services, comprising:
(a) a display component that displays the qualifications of service providers in a list of service providers identified by a remote server;
(b) an input component that permits a user to input proposal parameters and a service area requirement that define a request for proposal (RFP), the input of at least one or more proposal parameters and the service area requirement, causing the display component to display service providers that provide services corresponding to the one or more of the proposal parameters and meet the service area requirement, the input component further permitting the user to define a short list of service providers based on the service providers' qualifications displayed by the display component and simultaneously submit the RFP, using a single action, to the service providers on the short list via the remote server; and
(c) a communication component that provides a communication link to the remote server for submission of the RFP to the remote server for simultaneous distribution to the service providers on the short list.

29. The client system of claim 28, wherein the input component permits a user to amend the RFP after it has been submitted to the service providers on the short list, the amended RFP being submitted simultaneously to the service providers on the short list in response to a single action by the user.

30. The client system of claim 28, wherein the communication component is further configured to support a communication link from the remote server that permits the remote server to communicate one or more proposals received from a service provider on the short list to the client system, the display component displaying the one or more proposals when received by the client system.

31. The client system of claim 30, wherein the input component is further configured to amend a submitted RFP in response to a recommendation received from a service provider via the communication link from the remote server, the amended RFP being submitted simultaneously to the service providers on the short list.

32. The client system of claim 28, wherein the input component is further configured to permit a user to add service providers to the short list after the RFP has been submitted, the RFP being simultaneously submitted to the service providers added to the short list.

33. A service provider system for responding to a request for a proposal for provision of services, comprising:
(a) a display component that displays proposal parameters and a service area requirement set forth in a request for proposal (RFP) that has been received from a requesting party via a remote server;
(b) an input component that permits a service provider to retrieve from a memory in the remote server stored content that is used in preparing a proposal in response to the RFP, the stored content having been associated in the remote server with one or more of the proposal parameters in the RFP and being added to a draft proposal in fields corresponding to the proposal parameters, the input component further permitting the service provider to modify the stored content in the proposal before submitting the proposal to the requesting party via the remote server; and
(c) a communication component that provides a communication link with the remote server for receiving the RFP and submitting the proposal to the requesting party.

34. The service provider system of claim 33, wherein the input component is further configured to permit the service provider to amend the proposal after the proposal has already been submitted, the amended proposal being submitted to the requesting party via the remote server.
